(19) United States
(12) Patent Application Publication
(10) Pub. No.: US 2017/0217727 A1
(43) Pub. Date: Aug. 3, 2017

(54) ELEVATOR PASSENGER ENTRY DETECTION

(71) Applicant: Otis Elevator Company, Farmington, CT (US)

(72) Inventors: Bradley Armand Scoville, Farmington, CT (US); Paul A. Simcik, Southington, CT (US)

(21) Appl. No.: 15/328,238

(22) PCT Filed: Jul. 15, 2015
(86) PCT No.: PCT/US2015/040549

§ 371 Date: Jan. 23, 2017

Related U.S. Application Data
(60) Provisional application No. 62/028,536, filed on Jul. 24, 2014.

(51) Int. Cl. B66B 1/46

(52) U.S. Cl. CPC B66B 1/468; B66B 2201/4676; B66B 2201/4653; B66B 2201/4615

(57) ABSTRACT

An aspect of an elevator system includes receiving, from a user, a destination selection and assigning to the user a first elevator and notifying the user of the assignment. The user is detected in a second elevator, and the second elevator is controlled to travel to the destination selected by the user based on detecting the user in the second elevator.

### BACKGROUND OF THE INVENTION

Embodiments of the invention relate to elevator systems, and in particular, to controlling elevators based on detection of passengers in elevators.

Conventional elevator systems include a call button outside the elevator car and an operating panel inside the elevator car. A user calls an elevator from outside the elevator car, and typically indicates a desired direction (i.e. up or down). Upon entering the elevator, the user selects a desired floor.

Some elevator systems have begun to allow a user to request a particular floor from outside the elevator car. In such a system, a dispatch computer may receive the user's request and may assign a particular elevator car for the user. The computer may provide an indication to the user of which elevator car the user should use. In some systems, the user still must select the desired destination upon entering the elevator car. In other system, the elevator car is automatically controlled to travel to the requested destination. However, in such systems, if the user does not enter the recommended elevator, a decrease in efficiency occurs since the elevator may travel to a floor that no user in the elevator has requested.

### BRIEF DESCRIPTION OF THE INVENTION

Embodiments of the present invention include an elevator system including a destination selection device configured to receive a user input from a user to select a destination and an elevator assignment system configured to receive the selection of the destination from the destination selection device, to assign a first elevator to the user based on the selection of the destination, to detect the user in a second elevator, to determine whether the second elevator is the same as the first elevator, and to perform at least one of assigning the destination to the second elevator and providing feedback to the user based on determining whether the second elevator is the same as the first elevator.

In the above embodiment, or in the alternative, the elevator assignment system may be configured to assign the second elevator to the user, and assign the destination to the second elevator, based on determining that the second elevator in which the user is detected is not the same as the first elevator assigned to the user.

In any one of the above embodiments, or in the alternative, the elevator assignment system may be configured to provide feedback to the user based on determining that the second elevator in which the user is detected is not the same as the first elevator assigned to the user.

In any one of the above embodiments, or in the alternative, the elevator assignment system may be configured to detect an elevator change confirmation in response to the feedback, and to assign the destination to the second elevator based on detecting the elevator change confirmation.

In any one of the above embodiments, or in the alternative, the destination selection device may be a portable communications device associated with the user.

In any one of the above embodiments, or in the alternative, the destination selection device may be a cell phone.

In any one of the above embodiments, or in the alternative, the elevator system may include a user identification element and an identification element analysis unit in the first elevator configured to detect the user's identification by analyzing the user identification element.

In any one of the above embodiments, or in the alternative, the user identification element may include biometric data of the user and the identification element analysis unit is a biometric data reader.

In any one of the above embodiments, or in the alternative, the identification element analysis unit may include a camera that recognizes the user based on physical characteristic recognition of the user.

In any one of the above embodiments, or in the alternative, the user identification element may include a wireless communication element configured to communicate wireles sly with the identification element analysis unit to provide a user's identification to the elevator assignment system.

In any one of the above embodiments, or in the alternative, the user identification unit may be located inside the destination selection device.

Embodiments of the invention further include an elevator control system including memory for storing elevator assignments and a user identification database and a processor. The processor may be configured to receive from a user a destination selection and to assign a first elevator to the user based on receiving the destination selection from the user. The processor may be configured to receive from a user identification analysis unit in a second elevator user identification data, and to assign the destination selected by the user to the second elevator based on receiving the user identification data from the user identification analysis unit in the second elevator.

In any one of the above embodiments, or in the alternative, the processor may be configured to determine whether the second elevator from which the user identification data is received is the same as the first elevator assigned to the user, and to change an elevator assigned to the user from the first elevator to the second elevator, and to control the second elevator to travel to the destination selected by the user, based on determining that the second elevator is different from the first elevator.

In any one of the above embodiments, or in the alternative, the processor may be configured to determine whether the second elevator from which the user identification data is received is the same as the first elevator assigned to the user, and to control the second elevator to travel to the destination selected by the user based on determining that the second elevator is the same as the first elevator.

In any one of the above embodiments, or in the alternative, the processor may be configured to compare the user identification data received from the second elevator with user identification data stored in the user identification database to identify the user.

Embodiments of the invention further include a method for controlling an elevator. The method includes receiving, from a user, a destination selection and assigning to the user a first elevator and notifying the user of the assignment. The method includes detecting the user in a second elevator and controlling the second elevator to travel to the destination selected by the user based on detecting the user in the second elevator.

In any one of the above embodiments, or in the alternative, the method may include determining whether the second elevator in which the user is detected is the same as the first elevator assigned to the user and changing an assignment of the user from the first elevator to the second elevator based on determining that the second elevator is different from the first elevator.

In any one of the above embodiments, or in the alternative, receiving the destination selection from the user may include receiving, by an elevator assignment system, a destination selection signal from a portable communication device associated with the user.

In any one of the above embodiments, or in the alternative, detecting the user in the second elevator may include detecting wireless signals from a wireless identification element associated with the user.

In any one of the above embodiments, or in the alternative, detecting the user in the second elevator may include detecting biometric data associated with the user.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates an elevator system according to one embodiment of the invention;

FIG. 2 is a flow diagram of a method according to an embodiment of the invention;

FIG. 3 illustrates an example of a portable communications device according to an embodiment of the invention;

FIG. 4 illustrates an example of an identification element according to an embodiment of the invention; and

FIG. 5 illustrates a biometric identification element analysis system according to an embodiment of the invention.

### DETAILED DESCRIPTION OF THE INVENTION

Conventional elevator systems require users to select a desired destination upon entering an elevator car. Embodiments of the invention receive destination requests from users and automatically detect the presence of users in an elevator car to control the elevator car to travel to the requested destination.

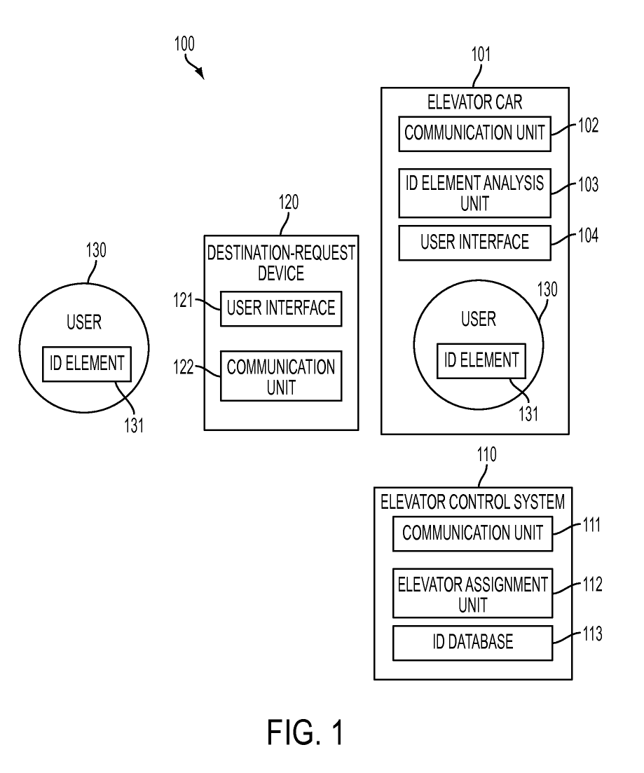

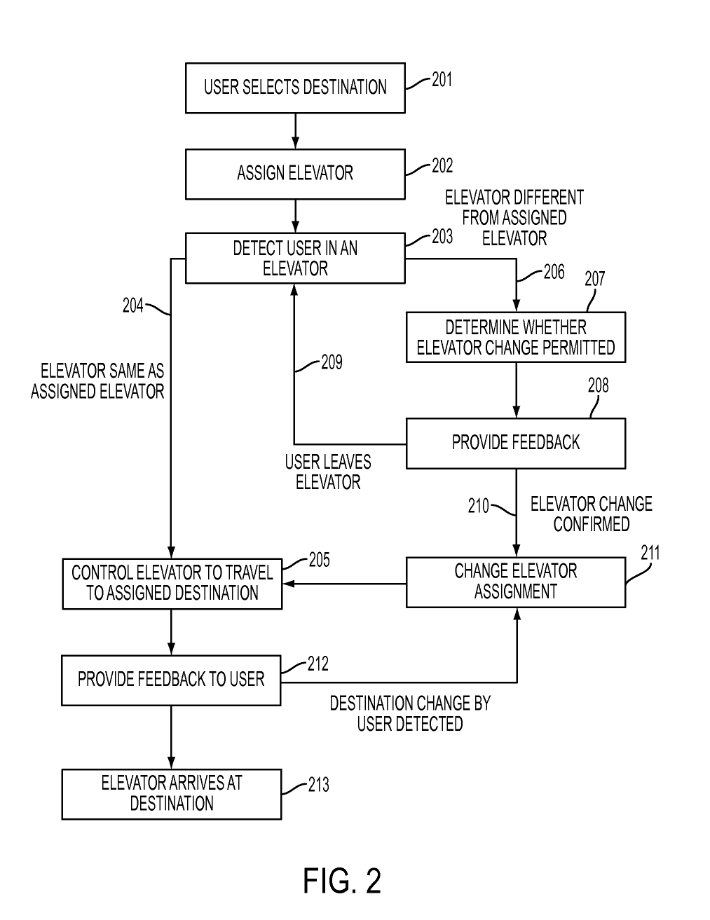

FIG. 1 illustrates an elevator system 100 according to an embodiment of the invention. FIG. 2 is a flow diagram of a method according to an embodiment of the invention. The system 100 includes an elevator car 101 and an elevator control system 110. The system 100 also includes a destination-request device 120 usable by a user 130 to request a destination in block 201 of FIG. 2. The destination-request device 120 may be a portable or stationary device. In one embodiment, the destination-request device is a portable communication device associated with the user 130, such as the user's cell phone, or a cell phone registered to or by the user 130. In another embodiment, the destination-request device 120 is a stationary panel or other stationary device located in the vicinity of an elevator bank or elevator doors, in a lobby, or in any other location accessible by the user 130.

In an embodiment in which the destination-request device 120 is a portable communication device, the user 130 may log in or otherwise register and select a destination via a user interface 121, such as a touch screen, keyboard, voice-activated controls, body-movement-activated controls, or any other method. Selecting a destination may include entering a floor number, business or tenant name, or any other information corresponding to a tenant of a building in which the elevator car 101 is located. The destination-request device 120 includes a communication unit 122 to transmit the destination request to the elevator control system 110. The communication unit 122 may be any wired or wireless communication system, including a wired or wireless local-area network (LAN), wide area network (WAN), or any other type of network.

The elevator control system 110 receives the destination selection via a corresponding communication unit 111 and, in block 202 of FIG. 2, assigns an elevator to the user with the elevator assignment unit 112. The elevator assignment unit 112 may include any combination of processors and memory executing instructions that incorporate any algorithm to assign an elevator, including determining a closest elevator to the user 130, a least-crowded elevator, an elevator capable of arriving at the selected destination, a particular type of elevator, such as a cargo elevator for service deliveries, or any other algorithm taking into account any predetermined criteria. In one embodiment, the elevator control system 110 controls an elevator to move to the user's location based on receiving the destination request. In one embodiment, the elevator control system 110 sends assignment information, such as an elevator number or other identifier, to the user 130 after assigning the elevator to the user 130. The assignment information may be displayed on the destination-request device 120 or on another device, such as a display in the vicinity of a bank of elevators.

In embodiments of the invention, the elevator control system 110 determines whether the user 130 enters the assigned elevator and takes actions based on the determination whether the user entered the assigned elevator. Accordingly, in FIG. 1, the user 130 is illustrated outside the elevator car 101, representing a location at which the user requests a destination, and inside the elevator car 101 where the user's identity is detected.

In particular, the user has an identification (ID) element 131 that is associated with the user, and the elevator car 101 has an identification (ID) element analysis unit 103 to identify the user based on the ID element 131. In block 203 of FIG. 2, the ID element analysis unit 103 analyzes the ID element 131 of the user 130 in the elevator car 101 to determine the user's identity. The ID element 131 may be a device, biometric characteristics of the user 130, or any other means of identifying a user. In one embodiment, the ID element 131 is a code or data generated by a portable communications device associated with the user 130, such as a user's cell phone. The data may be transmitted wirelessly, such as via a wireless LAN, Bluetooth, near-field communication systems, or any other infrared, radio frequency or other wireless system. In one embodiment, the destination-request device 120 is a cell phone associated with the user 130, and the ID element 131 is stored in, or part of, the cell phone.

The ID element 131 may also include any other device capable of emitting data, such as a radio-frequency identification (RFID) chip. Such an RFID chip may be powered off until an RF signal is received from the ID element analysis unit 103 that generates current in the RFID chip causing the RFID chip to emit identification data. In one embodiment, the ID element 131 is a card or badge, or is a chip embedded in the card or badge. While a few examples of devices have been provided by way of description, embodiments of the invention encompass any device capable of providing identification of a user 130 to an ID element analysis unit 103.

In addition or in the alternative, the ID element 131 may include biometric data of a user. For example, the ID element analysis unit 103 may be a camera or scanner capable of recognizing a user's features, such as a face, fingerprint, retina, or any other biometric data that can be used to identify the user. The elevator control system 110 stores identification data, such as identifying codes or biometric data, in the identification (ID) database 113 and compares detected identification information with the data in the database 113 to identify the user 130 in the elevator car 101.

The elevator control system 110 determines whether the elevator 101 in which the user 130 is located is the same elevator that was previously assigned to the user 130. In path 204 of FIG. 2, if the elevator control system 110 determines that the elevator 101 in which the user 130 is located is the same elevator that was assigned to the user 130, the elevator control system 110 controls the elevator car 101 to travel to the previously-assigned destination. The path to the previously-assigned destination may be by way of any other number of destinations based on the presence of additional users in the elevator car 101 or additional elevator requests from users outside the elevator car 101.

In path 206 of FIG. 2, if the elevator control system 110 determines that the elevator car 101 is not the same elevator that was assigned to the user, then the elevator control system 207 may determine whether an elevator change is permitted. For example, in a system in which some elevators access only some floors, a user may not be allowed to ride in an elevator that accesses floors the user is not permitted to access, or which does not access the floor the user has requested. In block 208, of FIG. 2, the elevator control system 110 may provide feedback to the user, such as by providing visual, audio, or other messages via the user interface 104 or the destination-request device 120. The feedback may be based on whether changes are permitted. For example, a feedback message may ask the user to confirm an elevator change by pressing a “door close” or “confirm change” button on the user interface 104 or destination-request device 120 in embodiments in which an elevator change is permitted. In addition, the feedback message may instruct the user to exit the elevator car 101 and enter another elevator in an embodiment in which an elevator change is not permitted. In these embodiments, the doors of the elevator car 101 may be controlled to remain open until a user action is detected, whether confirming an elevator change in path 210 of FIG. 2 or exiting the elevator in path 209. In one embodiment, the elevator control system 110 may send a message to the user's portable communications device with information such as the recommended elevator, an increased arrival time based on the elevator in which the user is presently located, an indication that the elevator in which the user is located is going the wrong direction (i.e. the user wants to go up, but the elevator is going down), any information indicating to the user why the non-assigned elevator in which the user is located is not ideal for the user, or any other information. The user 130 may then be given the opportunity to leave the elevator prior to the doors closing, or remain on the elevator, at which time the elevator control system 110 may change the elevator assigned to the user to correspond to the elevator in which the user is located.

If it is determined that the user has exited the elevator in path 209, the elevator doors may close and the elevator may continue to operate without the user. The user is then detected in another elevator in block 203, and the process of determining whether the user is in the assigned elevator repeats.

If the user confirms the elevator change in path 210, the elevator control system 110 may change the user's elevator assignment in block 211 and may then control the elevator to travel to the user's requested destination in block 205. In one embodiment, the user confirmation of path 210 requires an action or operation by the user, such as pressing a button, speaking a confirmation, or otherwise interacting with the user interface 104 or the destination-request device 120. In another embodiment, no user action is required, and the elevator control system 110 changes the elevator assignment based on the user simply remaining in the elevator for a predetermined period of time without performing any other operation or action, or without interacting with the user interface 104 or the destination-request device 120.

While an embodiment has been described in which the elevator control system 110 provides feedback to the user, in another embodiment, one or both of the blocks 205 and 211 of FIG. 2 are performed automatically by the elevator control system 110 without any user-initiated actions after entering the elevator car 101. For example, in one embodiment, the elevator control system 110 controls the elevator to travel to a requested destination or changes the requested destination without a user interacting with the user interface 104 in the elevator car (such as a control panel, keypad, audio interface, etc.), without requiring the user to move an ID badge or other user identification device or object into the vicinity of a reader or scanner, and without requiring the user to perform any other user-initiated action. Instead, the ID element analysis unit 103 may automatically detect the ID element 131, and the elevator control system 110 may perform the assignment change of block 207 or the elevator destination control of block 205 based on the ID element detection.

In one embodiment, the elevator control system 110 provides additional feedback to the user in block 212. The feedback may include, for example, audio, visual, tactile, or other notifications via a user interface 104 in the elevator car 104 or via a portable communications device, such as a cell phone, associated with the user. The content of the additional feedback may include the requested destination, time to arrival, or any other feedback. While FIG. 2 illustrates the providing of feedback downstream, or later than, the changing of the elevator assignment, it may be understood that the feedback may be provided prior to, or concurrently with, the changing of the elevator assignment, as described previously with respect to block 208 of FIG. 2.

In addition, in one embodiment the user may request a change in destination after entering an elevator car, as indicated by path 209 of FIG. 2. In such an embodiment, the elevator control system 110 may change the elevator assigned to the user (as illustrated in FIG. 2), or may simply change the destination of the elevator. For example, in an embodiment in which some elevators service only some destinations, a user may change a destination request to correspond to a location that is not serviced by the elevator in which the user is located. In such an embodiment, the elevator control system 110 may change the elevator assigned to the user, and may instruct the user, via a portable communications device, for example, how to access the assigned elevator. In another example, the user may realize that an incorrect destination was initially requested, and may request a different location serviced by the elevator. The elevator control system 110 may then merely change the destination of the elevator car 101. In such an embodiment, an efficiency of the elevator system 100 is realized, since the elevator control system 110 may skip the erroneously-selected destination if no other users have requested the destination.

In block 213 of FIG. 2, the elevator car 101 arrives at the requested destination.

While one ID element analysis unit 103 is illustrated in the box representing the elevator car 101, embodiments of the invention encompass any system that identifies whether users have entered particular elevator cars 101. For example, in one embodiment, ID element analysis units may be located at stationary locations at each door to an elevator on each separate floor of a building. In such an embodiment, each elevator car 101 has multiple ID element analysis units associated with it, so that each ID element analysis unit on each floor of the building tracks which users enter the particular elevator and which users leave the elevator, and the data from all of the ID element analysis units is transferred to the elevator control system 110 which tracks the occupancy of the elevators.

In addition, while an embodiment is illustrated in which the ID element analysis unit 103 identifies the ID element 131 of the user 130 to identify the user 130, embodiments also encompass other functions of the ID element analysis unit 103, such as tracking occupant who cannot be specifically identified. For example, in one embodiment guests to a building may be provided with badges that do not uniquely identify the guest, but instead identify the user as a “guest,” permitting the elevator control system 110 to track the location of the guest. In another embodiment, if the ID element analysis unit 103 is a biometric reader and does not recognize a particular user (i.e. the user is not in the ID database 113), the unidentified user may still be counted for purposes of determining the occupancy of the elevator car 101 or tracking the location of the unidentified user, while the user may be denied the destination-request function or access to predetermined locations in the building.

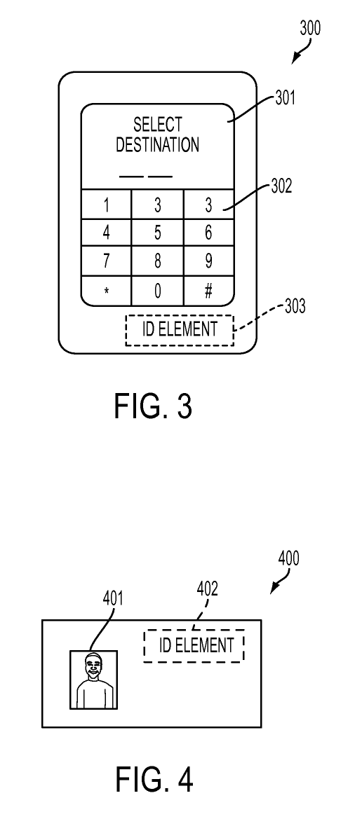

As previously discussed, embodiments of the invention encompass any type of ID element. FIG. 3 illustrates an embodiment in which the destination-request device is a portable communications device 300. The portable communications device 300 includes a display panel 301, user data entry buttons 302, and an ID element 303 included in the portable communications device 300. In one embodiment, the ID element includes code executed by a processor and transmitted wireles sly by an antenna. In another embodiment, the ID element 303 is an RFID chip embedded in the portable communications device 300.

FIG. 4 illustrates an embodiment in which the ID element 402 is embedded in a badge 400 or identification card including identification information 401, such as words, pictures, and other symbols. In such an embodiment, the ID element 402 may include an RFID chip, barcode, or other scannable or detectable code, symbol, design, or other feature.

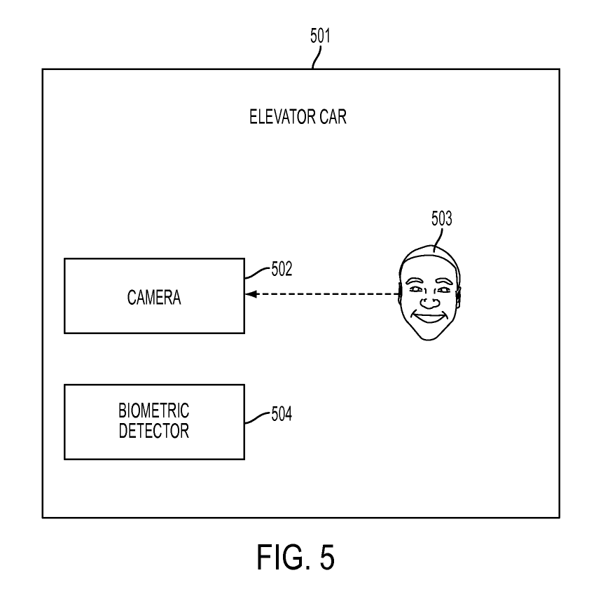

FIG. 5 illustrates yet another embodiment in which the ID element analysis unit includes a camera 502 and biometric detector 504 to identify biometric characteristics of a user 503 in an elevator car 501. For example, the camera 502 may identify facial or retinal characteristics, or the biometric detector 504 may detect fingerprints, palm prints, deoxyribonucleic acid (DNA) or other biological identifiers, or any other biometric data capable of identifying a user.

Technical effects of embodiments of the invention include increasing an efficiency of an elevator system by tracking users in elevators to reduce extra, erroneous, or unnecessary stops of the elevator, reducing the arrival of full elevators due to elevator calls from users outside the elevator, and providing security features to track users and grant access to destinations in a building based on a user's identification.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An elevator system, comprising:
a destination selection device configured to receive a user input from a user to select a destination; and
an elevator assignment system configured to receive the selection of the destination from the destination selection device, to assign a first elevator to the user based on the selection of the destination, to detect the user in a second elevator, to determine whether the second elevator is the same as the first elevator, and to perform at least one of assigning the destination to the second elevator and providing feedback to the user based on determining whether the second elevator is the same as the first elevator.

2. The elevator system of claim 1, wherein the elevator assignment system is configured to assign the second elevator to the user, and assign the destination to the second elevator, based on determining that the second elevator in which the user is detected is not the same as the first elevator assigned to the user.

3. The elevator system of claim 1, wherein the elevator assignment system is configured to provide feedback to the user based on determining that the second elevator in which the user is detected is not the same as the first elevator assigned to the user.

4. The elevator system of claim 3, wherein the elevator assignment system is configured to detect an elevator change confirmation in response to the feedback, and to assign the destination to the second elevator based on detecting the elevator change confirmation.

5. The elevator system of claim 1, wherein the destination selection device is a portable communications device associated with the user.

6. The elevator system of claim 5, wherein the destination selection device is a cell phone.

7. The elevator system of claim 1, further comprising:
a user identification element; and
an identification element analysis unit in the second elevator configured to detect the user's identification by analyzing the user identification element.

8. The elevator system of claim 7, wherein the user identification element is biometric data of the user and the identification element analysis unit is a biometric data reader.

9. The elevator system of claim 7, wherein the identification element analysis unit is a camera that recognizes the user based on physical characteristic recognition of the user.

10. The elevator system of claim 7, wherein the user identification element is a wireless communication element configured to communicate wireles sly with the identification element analysis unit to provide a user's identification to the elevator assignment system.

11. An elevator control system, comprising:
memory for storing elevator assignments and a user identification database; and
a processor configured to receive from a user a destination selection and to assign a first elevator to the user based on receiving the destination selection from the user, the processor configured to receive from a user identification analysis unit in a second elevator user identification data, and to assign the destination selected by the user to the second elevator based on receiving the user identification data from the user identification analysis unit in the second elevator.

12. The elevator control system of claim 11, wherein the processor is configured to determine whether the second elevator from which the user identification data is received is the same as the first elevator assigned to the user, and to change an elevator assigned to the user from the first elevator to the second elevator, and to control the second elevator to travel to the destination selected by the user, based on determining that the second elevator is different from the first elevator.

13. The elevator control system of claim 11, wherein the processor is configured to determine whether the second elevator from which the user identification data is received is the same as the first elevator assigned to the user, and to control the second elevator to travel to the destination selected by the user based on determining that the second elevator is the same as the first elevator.

14. The elevator control system of claim 11, wherein the processor is configured to compare the user identification data received from the second elevator with user identification data stored in the user identification database to identify the user.

15. A method for controlling an elevator, comprising:
receiving, from a user, a destination selection;
assigning to the user a first elevator and notifying the user of the assignment;
detecting the user in a second elevator; and
controlling the second elevator to travel to the destination selected by the user based on detecting the user in the second elevator.

16. The method of claim 15, further comprising:
determining whether the second elevator in which the user is detected is the same as the first elevator assigned to the user; and
changing an assignment of the user from the first elevator to the second elevator based on determining that the second elevator is different from the first elevator.

17. The method of claim 15, wherein receiving the destination selection from the user includes receiving, by an elevator assignment system, destination selections signal from a portable communication device associated with the user.

18. The method of claim 17, wherein the portable communication device is a cell phone.

19. The method of claim 15, wherein detecting the user in the second elevator includes detecting wireless signals from a wireless identification element associated with the user.

20. The method of claim 15, wherein detecting the user in the second elevator includes detecting biometric data associated with the user.
